(19) United States
(12) Patent Application Publication
(10) Pub. No.: US 2020/0208460 A1
(43) Pub. Date: Jul. 2, 2020

(54) VEHICLE HANDS-FREE SYSTEM

(71) Applicant: Brose Fahrzeugteile GmbH & Co. Kommanditgesellschaft, Bamberg, Bamberg (DE)

(72) Inventors: Zikang MA, Rochester Hills, MI (US); Alex POLONSKY, Troy, MI (US); Kilian von Neumann-Cosel, Menlo Park, CA (US)

(21) Appl. No.: 16/233,249

(22) Filed: Dec. 27, 2018

(51) Int. Cl. E05F 15/73; E05F 15/689

(52) U.S. Cl. CPC E05F 15/73; E05F 15/689

(57) ABSTRACT

Vehicle hands-free liftgate systems of vehicles. Responsive to an object movement at the rear of the vehicle during a first vehicle mode, proximity signals generated by proximity sensors of the vehicle responsive to the object movement are associated with an actuation case, and responsive to another object movement at the rear of the vehicle during a second vehicle mode, proximity signals generated by the proximity sensors responsive to the another object movement are associated with a non-actuation case. A classifier is generated based on application of the proximity signals and associations to a machine learning algorithm. Responsive to a further object movement associated with the actuation case at the rear of the vehicle during a third vehicle mode, a determination is made that the further object movement is associated with the actuation case based on the classifier. Responsive to the determination, the liftgate is actuated.

### TECHNICAL FIELD

Aspects of this disclosure generally relate to vehicle hands-free systems.

### BACKGROUND

Hands-free liftgates enable users to access the trunk area of their vehicles using a kick gesture. This feature is useful when a user's hands are indisposed.

### SUMMARY

In one exemplary embodiment, a vehicle includes a powered liftgate, first and second proximity sensors positioned at a rear end of the vehicle, and at least one controller coupled to the first and second proximity sensors. The at least one controller is configured to, responsive to a first object movement at the rear end of the vehicle during a first vehicle mode, associate first and second proximity signals generated by the first and second proximity sensors respectively in response to the first object movement with an actuation case. The first and second proximity signals illustrate the movement of the first object towards and then away from the first and second proximity sensors respectively. The at least one controller is further configured to, responsive to a second object movement at the rear end of the vehicle during a second vehicle mode, associate third and fourth proximity signals generated by the first and second proximity sensors respectively in response to the second object movement with a non-actuation case. The third and fourth proximity signals illustrate the movement of the second object towards and then away from the first and second proximity sensors respectively. The at least one controller is also configured to generate a classifier based on application of the first, second, third, and fourth proximity signals, the association of the first and second proximity signals with the actuation case, and the association of the third and fourth proximity signals with the non-actuation case to a machine learning algorithm.

In addition, responsive to a third object movement associated with the actuation case at the rear end of the vehicle during a third vehicle mode, the at least one controller is configured to determine that the third object movement is associated with the actuation case based on application of fifth and sixth proximity signals generated by the first and second proximity sensors respectively in response to the third object movement to the classifier. The fifth and sixth proximity signals illustrate the movement of the third object towards and then away from the first and second proximity sensors respectively. Responsive to the determination, the at least one controller is configured to transmit a signal to actuate the liftgate.

In another exemplary embodiment, a system for improving operation of a powered liftgate of a first vehicle includes at least one processor. The at least one processor is programmed to, responsive to receiving first proximity signal sets generated by first and second proximity sensors of a second vehicle in response to a plurality of first object movements that are actuation gestures occurring at a rear end of the second vehicle, associate each of the first proximity signal sets with an actuation case. Each first proximity signal set includes first and second proximity signals that are generated respectively by the first and second proximity sensors and that illustrate the movement of the first object towards and then away from the first and second proximity sensors respectively. The at least one processor is also programmed to, responsive to receiving second proximity signal sets generated by the first and second proximity sensors of the second vehicle in response to a plurality of second object movements that are non-actuation gestures occurring at the rear end of the second vehicle, associate each of the second proximity signal sets with a non-actuation case. Each second proximity signal set includes third and fourth proximity signals that are generated respectively by the first and second proximity sensors and that illustrate the movement of the second object towards and then away from the first and second proximity sensors respectively. The at least one processor is further programmed to generate a classifier based on application of the first proximity signal sets, the second proximity signal sets, the association of the first proximity signal sets with the actuation case, and the association of the second proximity signal sets with the non-actuation case to a machine learning algorithm.

In addition, responsive to a third object movement associated with the actuation case occurring at a rear end of the first vehicle, the first vehicle is configured to determine that the third object movement is associated with the actuation case based on application of a third proximity signal set generated by first and second proximity sensors of the first vehicle in response to the third object movement to the classifier. The third proximity signal set includes fifth and sixth proximity signals that are generated by the first and second proximity sensors of the first vehicle respectively and that illustrate the movement of the third object towards and then away from the first and second proximity sensors of the first vehicle respectively. Responsive to the determination, the first vehicle is programmed to actuate the liftgate.

In a further exemplary embodiment, a first vehicle includes a powered liftgate, first and second proximity sensors positioned at a rear end of the first vehicle, and at least one controller coupled to the first and second proximity sensors. The at least one controller is configured to retrieve a classifier generated by application to a machine learning algorithm of first proximity signal sets generated by first and second proximity sensors of a second vehicle in response to a plurality of first object movements that are actuation gestures occurring at a rear end of the second vehicle, and of an association of each of the first proximity signal sets with an actuation case. Each first proximity signal set includes first and second proximity signals that are generated respectively by the first and second proximity sensors of the second vehicle and that illustrate the movement of the first object towards and then away from the first and second proximity sensors of the second vehicle respectively. The classifier is further generated by application to the machine learning algorithm of second proximity signal sets generated by the first and second proximity sensors of the second vehicle in response to a plurality of second object movements that are non-actuation gestures occurring at the rear end of the second vehicle, and of an association of each of the second proximity signal sets with a non-actuation case. Each second proximity signal set includes third and fourth proximity signals that are generated respectively by the first and second proximity sensors of the second vehicle and that illustrate the movement of the second object towards and then away from the first and second proximity sensors of the second vehicle respectively.

Furthermore, responsive to a third object movement associated with the actuation case occurring at the rear end of the first vehicle, the one or more controllers are configured to determine that the third object movement is associated with the actuation case based on application of a third proximity signal set generated by the first and second proximity sensors of the first vehicle in response to the third object movement to the classifier. The third proximity signal set includes fifth and sixth proximity signals that are generated by the first and second proximity sensors of the first vehicle respectively and that illustrate the movement of the third object towards and then away from the first and second proximity sensors of the first vehicle respectively. Responsive to the determination, the one or more controllers are configured to transmit a signal to actuate the liftgate.

### BRIEF DESCRIPTION OF THE DRAWINGS

FIG. 1 is a schematic diagram of a system for a hands-free control system of a vehicle.

FIG. 2 is a schematic diagram of a computing platform that may be utilized in the system of FIG. 1.

FIG. 3 is a flowchart of a hands-free control process for a vehicle that may be implemented by the system of FIG. 1.

FIG. 4 is a graph of a proximity signal that may be generated by a proximity sensor of a vehicle.

FIG. 5 is a graph of a proximity signal that may be generated by another proximity sensor of a vehicle.

FIG. 6 is a graph of the proximity signals of FIGS. 4 and 5 after the proximity signals have been normalized.

FIG. 7 is a graph of a classifier function that may be generated by a machine learning algorithm based on training data derived from proximity signals generated by proximity sensors of a vehicle.

FIG. 8 is graph of a classifier function that may be generated by another machine learning algorithm based on training data derived from proximity signals generated by proximity sensors of a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

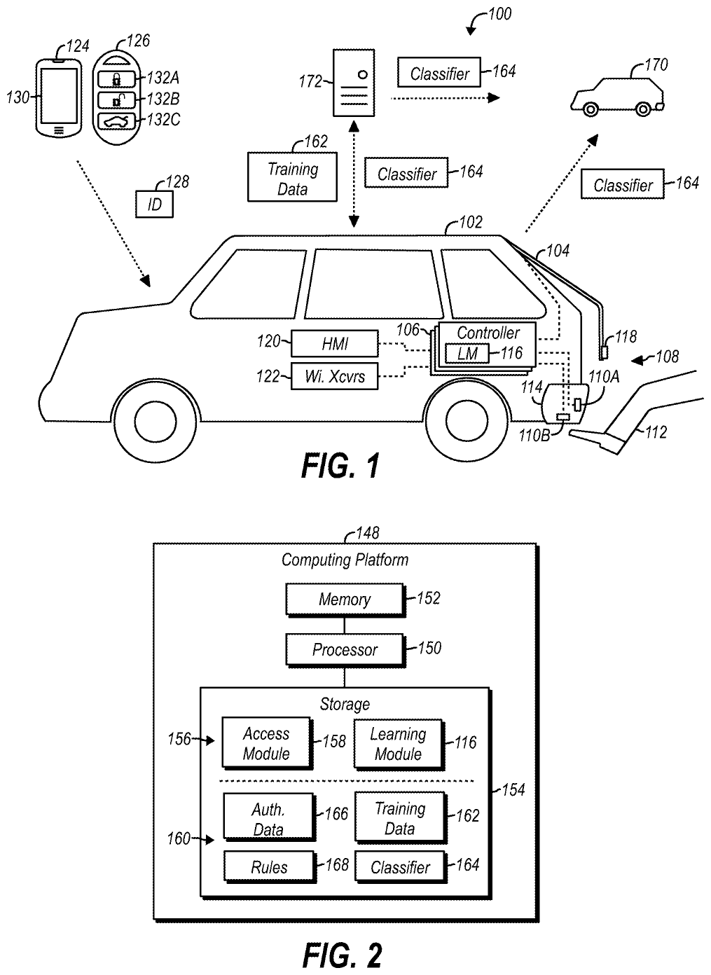

FIG. 1 illustrates a hands-free control system 100 of a vehicle. A vehicle may include a system, such as a liftgate, controllable via a hands-free gesture. For example, the vehicle may include rear end proximity sensors that, responsive to an object motion at the rear end of the vehicle, generate a set of proximity signals. Each proximity signal of the set may be generated by a different one of the proximity sensors and may illustrate the movement of the object relative to the different sensor. A controller of the vehicle may analyze the proximity signal set to determine whether it represents an actuation gesture, such as a user kicking his or her leg underneath the rear end of the vehicle, or a non-actuation gesture, such as a user walking past the rear end of the vehicle without perform any suck kick. If the proximity signal set is determined to represent the actuation gesture, then the controller may transmit a signal causing the liftgate to actuate. This hands-free control system enables a user to open and/or close the vehicle liftgate when the user's hands are indisposed (e.g., carrying groceries).

The proximity signals generated responsive to an actuation gesture may differ from the proximity signals generated responsive to a non-actuation gesture. Moreover, due to variations in the performance of an actuation gesture by different users and by a same user at different times, and varying environmental conditions, an actuation gesture conducted at one time may generate a proximity signal set differing from the proximity signal set generated by an actuation gesture conducted at another time. Reliability of the hands-free liftgate system thus depends on the controller's ability to distinguish between proximity signal sets generated responsive to varying actuation gestures and proximity signal sets generated responsive to varying non-actuation gestures.

The system 100 allows the controller to recognize and distinguish between varying actuation gestures and varying non-actuation gestures. In one or more embodiments, a controller of the vehicle may be configured to perform a specific and unconventional process in which it applies proximity signals each generated by the proximity sensors while the vehicle is in an actuation learning mode, and proximity signals each generated while the vehicle is in a non-actuation learning mode, to a machine learning algorithm. In one or more embodiments, while the vehicle is in the actuation learning mode, a user may perform one or more object movements intended to be actuation gestures, and the controller may assume that the resulting proximity signals were generated responsive to actuation gestures. Similarly, while the vehicle is in the non-actuation learning mode, a user may perform one or more object movements intended to be non-actuation gestures, and the controller may assume that the resulting proximity signals were generated responsive to a non-actuation gesture. Based on the application to a machine learning algorithm of data describing the proximity signals generated during the learning modes and indicating which proximity signals were generated responsive to an actuation gesture and which were generated responsive to a non-actuation gesture, the controller may generate a classifier that generalizes the differences between proximity signals generated responsive to actuation gestures and to non-actuation gestures. This classifier may improve the vehicle's ability to recognize and distinguish between varying actuation gestures and varying non-actuation gestures, and correspondingly to improve reliability of the hands-free liftgate.

The system 100 may include a vehicle 102 with a hands-free liftgate 104. The liftgate 104 may be a powered liftgate. The liftgate 104 may be coupled to a motor, which may be coupled to one or more controllers 106 of the vehicle 102. The one or more controllers 106 may be capable of transmitting an actuation signal to the motor that causes the motor to actuate (e.g., open and close) the liftgate 104.

The one or more controllers 106 may be coupled to proximity sensors 110 positioned at the rear end 108 of the vehicle 102. Responsive to an object movement occurring at the rear end 108 of the vehicle 102, the proximity sensors 110 may be configured to generate a proximity signal set, each of the proximity signals of the set being generated by a different one of the proximity sensors 110 and illustrating the movement of the object relative to the proximity sensor 110. For example, each proximity signal may illustrate the movement of the object towards and then away from the proximity sensor 110 over time, such as by indicating the changing distance between the object and proximity sensor 110 over time. The one or more controllers 106 may then determine whether the proximity signal set generated by the proximity sensors 110 represents an actuation gesture. If so, then the controller 106 may cause the liftgate 104 to open if it is currently closed, and to close if it is current open. If not, then the controller 106 may take no action to open or close the liftgate 104. In this way, the user is able to open and close the liftgate 104 with a simple gesture, such as a kick of the user's leg 112, which is of value if the user's hands are indisposed.

The proximity sensors 110 may be located within a bumper 114 of the rear end 108 of the vehicle 102. A user may perform an actuation gesture by extending the user's leg 112 proximate or under the bumper 114 and subsequently retracting the leg 112 from under the bumper 114 (e.g., a kick gesture). Although two proximity sensors 110, namely an upper proximity sensor 110A and a lower proximity sensor 110B, are shown in the illustrated embodiment, additional proximity sensors 110 configured to generate a proximity signal responsive to an object movement may be positioned at the rear end 108 of the vehicle 102 and coupled to the one or more controllers 106. Each of the proximity sensors 110 may be a capacitive sensor. Alternatively, one or more of the proximity sensors 110 may be an inductive sensor, a magnetic sensor, a RADAR sensor, or a LIDAR sensor.

As previously described, proper control of the hands-free liftgate 104 depends on the one or more controllers' 106 ability to differentiate between proximity signal sets generated responsive to varying actuation gestures and proximity signal sets generated responsive to varying non-actuation gestures. Accordingly, the one or more controllers 106 may be configured to implement a learning module 116 that provides the ability for one or more controllers' 106 to perform such differentiation, which is described in more detail below.

The liftgate 104 may include a manual actuator 118, such as a handle or button. Responsive to a user interaction with the manual actuator 118, the liftgate 104 may unlock to enable the user to manually open the liftgate 104. In addition, or alternatively, responsive to a user interaction with the manual actuator 118, the manual actuator 118 may transmit, such as directly or via the one or more controllers 106, a signal to the motor coupled to the liftgate 104 that causes the motor to open (or close) the liftgate 104.

The vehicle 102 may also include an HMI 120 and wireless transceivers 122 coupled to the one or more controllers 106. The HMI 120 may facilitate user interaction with the one or more controllers 106. The HMI 120 may include one or more video and alphanumeric displays, a speaker system, and any other suitable audio and visual indicators capable of providing data from the one or more controllers 106 to a user. The HMI 120 may also include a microphone, physical controls, and any other suitable devices capable of receiving input from a user to invoke functions of the one or more controllers 106. The physical controls may include an alphanumeric keyboard, a pointing device (e.g., mouse), keypads, pushbuttons, and control knobs. A display of the HMI 120 may also include a touch screen mechanism for receiving user input.

The wireless transceivers 122 may be configured to establish wireless connections between the one or more controllers 106 and devices local to the vehicle 102, such as a mobile device 124 or a wireless key fob 126, via RF transmissions. The wireless transceivers 122 (and each of the mobile device 124 and the key fob 126) may include, without limitation, a Bluetooth transceiver, a ZigBee transceiver, a Wi-Fi transceiver, a radio-frequency identification (“RFID”) transceiver, a near-field communication (“NFC”) transceiver, and/or a transceiver designed for another RF protocol particular to a remote service provided by the vehicle 102. For example, the wireless transceivers 122 may facilitate vehicle 102 services such as keyless entry, remote start, passive entry passive start, and hands-free telephone usage.

Each of the mobile device 124 and the key fob 126 may include an ID 128 electronically stored therein that is unique to the device. Responsive to a user bringing the mobile device 124 or key fob 126 within communication range of the wireless transceivers 122, the mobile device 124 or key fob 126 may be configured to transmit its respective ID 128 to the one or more controllers 106 via the wireless transceivers 122. The one or more controllers 106 may then recognize whether the mobile device 124 or key fob 126 is authorized to connect with and control the vehicle 102, such as based on a table of authorized IDs electronically stored in the one or more controllers 106.

The wireless transceivers 122 may include a wireless transceiver positioned near and associated with each access point of the vehicle 102. The one or more controllers 106 may be configured to determine a location of the mobile device 124 or key fob 126 relative to the vehicle 102 based on the position of the wireless transceiver 122 that receives the ID 128 from the mobile device 124 or key fob 126, or based on the position of the wireless transceiver 122 that receives a strongest signal from the mobile device 124 or key fob 126. For example, one of the wireless transceivers 122 may be positioned at the rear end 108 of the vehicle 102, and may be associated with the liftgate 104. Responsive to this wireless transceiver 122 receiving an ID 128 from a nearby mobile device 124 or key fob 126 or receiving a strongest signal from the nearby mobile device 124 or key fob 126 relative to the other wireless transceivers 122, the one or more controllers 106 may be configured to determine that the mobile device 124 or key fob 126 is located at the rear end 108 of the vehicle 102.

The transmission of the ID 128 may occur automatically in response to the mobile device 124 or key fob 126 coming into proximity of the vehicle 102 (e.g., coming into communication range of at least one of the wireless transceivers 122). Responsive to determining that a received ID 128 is authorized, the one or more controllers 106 may enable access to the vehicle 102. For example, the one or more controllers 106 may automatically unlock the access point associated with the wireless transceiver 122 determined closest to the mobile device 124 or key fob 126. As another example, the one or more controllers 106 may unlock an access point responsive to the authorized user interacting with the access point (e.g., placing a hand on a door handle or the manual actuator 118). As a further example, the one or more controllers 106 may be configured to only process a vehicle mode change request, or accept an actuation gesture and responsively operate the liftgate 104, if a mobile device 124 or key fob 126 having an authorized ID 128 is determined to be in proximity of and/or at the rear end 108 of the vehicle 102.

Alternatively, the transmission of the ID 128 may occur responsive to a user interaction with a touch screen display 130 of the mobile device 124, or with a button 132 of the key fob 126, to cause the mobile device 124 or key fob 126, respectively, to transmit a command to the one or more controllers 106. Responsive to authenticating the received ID 128, the one or more controllers 106 may execute the received command. For example, the one or more controllers 106 may execute a lock command received responsive to a user selection of a lock button 132A of the key fob 126 by locking the vehicle 102, an unlock command received responsive to a user selection of an unlock button 132B of the key fob 126 by unlocking the vehicle 102, and a trunk open command received responsive to a user selection of a trunk button 132C of the key fob 126 by unlocking the liftgate 104 and/or causing a motor to actuate the liftgate 104. As a further example, the one or more controllers 106 may execute a mode change command transmitted from the mobile device 124 or key fob 126 by changing the current mode of the learning module 116 to the mode indicated in the command (e.g., actuation learning mode, non-actuation learning mode, normal operating mode).

Each of the one or more controllers 106 may include a computing platform, such as the computing platform 148 illustrated in FIG. 2. The computing platform 148 may include a processor 150, memory 152, and non-volatile storage 154. The processor 150 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 152. The memory 152 may include a single memory device or a plurality of memory devices including, but not limited to, random access memory (“RAM”), volatile memory, non-volatile memory, static random access memory (“SRAM”), dynamic random access memory (“DRAM”), flash memory, cache memory, or any other device capable of storing information. The non-volatile storage 154 may include one or more persistent data storage devices such as a hard drive, optical drive, tape drive, non-volatile solid state device, or any other device capable of persistently storing information.

The processor 150 may be configured to read into memory 152 and execute computer-executable instructions embodying controller software 156 residing in the non-volatile storage 154. The controller software 156 may include operating systems and applications. The controller software 156 may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by the processor 150, the computer-executable instructions of the controller software 156 may cause the computing platform 148 to implement one or more of the learning module 116 and an access module 158. The learning module 116 and the access module 158 may each be computer processes configured to implement the functions and features of the one or more controllers 106 described herein. For example, the learning module 116 may be configured to generate a gesture classifier by applying proximity signals generated by the proximity sensors 110 during the actuation learning mode and proximity signals generated by the proximity sensors 110 during the non-actuation learning mode to a machine learning algorithm. The access module 158 may be configured to apply proximity signals generated by the proximity sensors 110 during the normal operating mode to the classifier to determine whether the object movement that caused the proximity signals is an actuation gesture or a non-actuation gesture. Responsive to determining that the object movement is an actuation gesture, the access module 158 may be configured to actuate the liftgate 104 by transmitting a signal to a motor coupled to the liftgate 104.

The non-volatile storage 154 may also include controller data 160 supporting the functions, features, and processes of the one or more controllers 106 described herein. For example, the controller data 160 may include one or more of training data 162, a classifier 164, authentication data 166, and rules 168.

The training data 162 may include data derived from proximity signal sets generated by the proximity sensors 110 responsive to several object movements occurring during the actuation learning mode, and from proximity signal sets generated by the proximity sensors 110 responsive to several object movements occurring during the non-actuation learning mode. The proximity signal sets generated during the actuation learning mode may be assumed to each represent an actuation gesture, and the proximity signal sets generated during the non-actuation learning mode may be assumed to each represent a non-actuation gesture. The training data 162 may thus associate the data derived from the proximity signals generated during the actuation learning mode with an actuation case and may associate the data derived from the proximity signals generated during a non-actuation learning mode with the non-actuation case.

The classifier 164 may be generated by the learning module 116 responsive to applying the training data 162 to a machine learning algorithm. The classifier 164 may include a function that enables the access module 158 to distinguish between proximity signal sets generated responsive to actuation gestures and those generated responsive to non-actuation gestures with improved accuracy.

The authentication data 166 may include a table of IDs 128 having authority to connect with and command the vehicle 102. Responsive to receiving an ID 128 from the mobile device 124 or key fob 126, the access module 158 may be configured to query the authentication data 166 to determine whether access to the vehicle 102 should be granted, as described above.

The rules 168 may be configured to facilitate continued improvement of the hands-free liftgate 104 by the learning module 116 when the vehicle 102 is in the normal operating mode. Specifically, each of the rules 168 may define criteria in which an object movement classified as a non-actuation gesture by the access module 158 should rather have been classified as an actuation gesture. Responsive to the criteria of one of the rules 168 being true, the learning module 116 may be configured to update the classifier 164 based on the proximity signals generated responsive to the falsely classified object movement.

The system 100 illustrated in FIG. 1 may also include another vehicle 170. The vehicle 170 may be of the same make and model of the vehicle 102, and may include the same or similar components as the vehicle 102 (e.g., hands-free liftgate 104, proximity sensors 110 controllers 106 implementing at least the access module 158 and including the associated controller data 160, wireless transceivers 122). Responsive to generation of the classifier 164 by the vehicle 102, the classifier 164 may be transferred to the vehicle 170 for electronic storage therein. After the transfer, responsive to an object movement occurring at a rear end of the vehicle 170, an access module 158 of the vehicle 170 may retrieve the classifier 164 from electronic storage. The access module 158 may then determine whether the object movement is associated with the actuation case based on application of the proximity signal set generated by the proximity sensors 110 of the vehicle 170 responsive to the object movement to the classifier, as described in additional detail below. If so, then the access module 158 of the vehicle 170 may similarly transmit a signal that actuates its liftgate 104. In this way, the classifier 164 generated by the learning module 116 of the vehicle 102 may serve to benefit other similar vehicles, such as the vehicle 170.

In some embodiments, the system 100 may also include an external computing device 172, such as laptop, desktop, server, or cloud computer, that is external to the vehicle 102. The external computing device 172 may be configured to implement at least a portion of the learning module 116. For example, the external computing device 172 may be coupled to the proximity sensors 110 of the vehicle 102, such as via the controllers 106 and/or a controller area network (CAN) bus of the vehicle 102. The learning module 116 of the external computing device 172 may be configured to generate the classifier 164 based on training data 162 derived from proximity signal sets generated by the proximity sensors 110 of the vehicle 102, as described in additional detail below. After the classifier 164 is generated by the external computing device 172, the classifier 164 may transferred to the vehicle 102 and/or other similar vehicles, such as the vehicle 170, for utilization by the access module 158 of the vehicle 102 and/or the other vehicles. In this way, the system 100 may be able to take advantage of increased computing power that may be provided by the external computing device 172 relative to the controllers 106 of the vehicle 102.

While an exemplary system 100 and an exemplary computing platform 148 are shown in FIGS. 1 and 2 respectively, these examples are not intended to be limiting. Indeed, the system 100 and/or computing platform 148 may have more or fewer components, and alternative components and/or implementations may be used. For example, the learning module 116 and the access module 158 may each be implemented by a same one of the controllers 106, or may each be implemented by a different one of the controllers 106. Similarly, the controller data 160 be stored in the non-volatile storage 154 of one of the controllers 106, or may be spread across multiple controllers 106. Specifically, the authentication data 166 and the classifier 164 may be included in the non-volatile storage 154 of a controller 106 configured to implement the access module 158, and the training data 162 and the rules 168 may be stored in the non-volatile storage 154 of a controller 106 configured to implement the learning module 116. The described functions of the access module 158 and/or the learning module 116 may also be spread across multiple controllers 106.

Similar to the controllers 106, each of the mobile device 124, the key fob 126, and the external computing device 172 may include a processor, memory, and non-volatile storage including data and computer-executable instructions that, upon execution by the processor, causes the processor to implement the functions, features, and processes of the device described herein. For example, the non-volatile storage of the mobile device 124 and key fob 126 may store the ID 128 specific to the mobile device 124 and key fob 126, respectively. Responsive to the mobile device 124 or key fob 126 coming within communication range of the wireless transceivers 122, the computer-executable instructions may upon execution cause the mobile device 124 or key fob 126, respectively, to retrieve its ID 128 from its respective non-volatile storage, and to transmit the ID 128 to the one or more controllers 106 via the wireless transceivers 122.

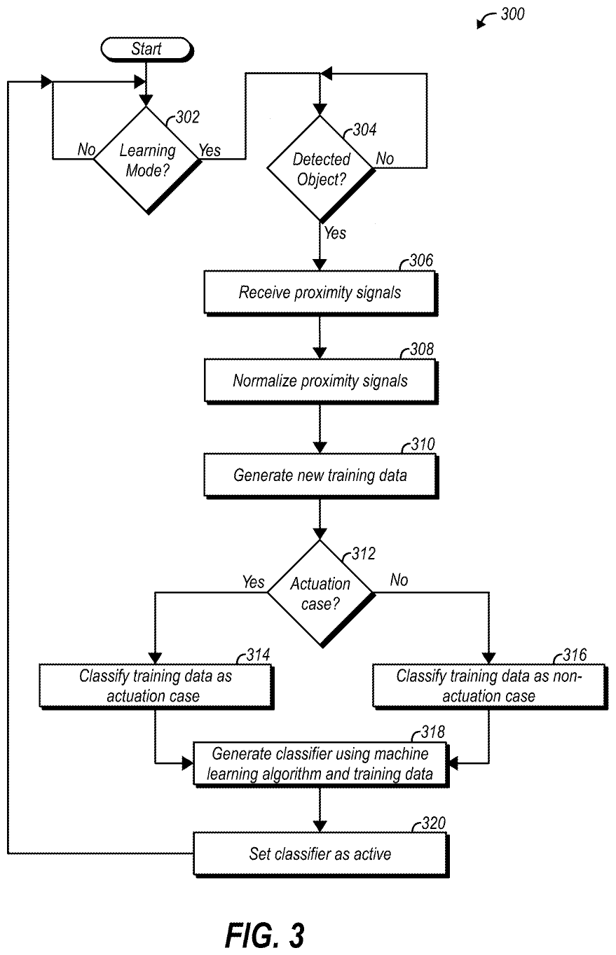

FIG. 3 illustrates a process 300 relating to the vehicle's 102 ability to differentiate between an actuation gesture for the liftgate 104 and a non-actuation gesture. The process 300 may be performed by the vehicle 102, or more particularly by the learning module 116.

In block 302, a determination may be made of whether a vehicle learning mode has been activated. Specifically, the vehicle 102, or more particularly the learning module 116, may be in one of several vehicle modes at a given time. When the learning module 116 is in the actuation learning mode, the learning module 116 may be configured to assume that object movements causing the generation of proximity signal sets are actuation gestures. Alternatively, when the learning module 116 is in the non-actuation learning mode, the learning module 116 may be configured to assume that object movements causing the generation of proximity signal sets are non-actuation gestures. In either case, when the learning module 116 is in one of these learning modes, the learning module 116 may bypass the access module 158 such that actuation gestures do not cause the liftgate 104 to actuate. In this way, a user can perform several object movements causing the proximity sensors 110 to generate proximity signal sets for use by the learning module 116 for training without the liftgate 104 opening and closing. When the learning module 116 is not in a learning mode, but rather in a normal vehicle operating mode, the access module 158 may be configured, responsive to an object movement at the rear end 108 of the vehicle 102, to determine whether a proximity signal set generated by the proximity sensors 110 responsive to an object movement represents an actuation gesture or a non-actuation gesture.

A user may interact with the vehicle 102 to change the current mode of the learning module 116. For example, a user may utilize the HMI 120 (e.g., user interface shown on a center console display) to transmit a command to the learning module 116 that causes the learning module 116 to change to one of the modes. As a further example, a user may interact with a user interface shown on the display 130 of the mobile device 124 to wirelessly transmit a command to the learning module 116 that causes the learning module 116 to change to one of the modes.

In another example, a user may interact with a key fob 126 to wirelessly transmit a command to the learning module 116 that causes the learning module 116 to change modes. Specifically, the key fob 136 may be configured such that each of the buttons 132 is associated with a primary command such as unlock, lock, and trunk open, and with a secondary command such as one of the learning modes and the normal vehicle operating mode. The key fob 136 may be configured to transmit the primary command to the vehicle 102 for a given button 132 responsive to a relatively short press or a single press of the button 132, and may be configured to transmit the secondary command for the given button 132 responsive to a relatively long press or a multiple press (e.g., double press, triple press) of the given button 132 within a set time frame.

For instance, responsive to a relatively long press of the lock button 132A on the key fob 126, the key fob 126 may be configured to transmit a command to the learning module 116 that causes the learning module 116 to activate the non-actuation learning mode; responsive to a relatively long press of the unlock button 132B on the key fob 126, the key fob 126 may be configured to transmit a command to the learning module 116 that causes the learning module 116 to activate the actuation learning mode; and responsive to a relatively long press of the trunk button 132C on the key fob 126, the key fob 126 may be configured to transmit a command to the learning module 116 that causes the learning module 116 to activate the normal vehicle operating mode. Prior to changing modes based on a command received from the mobile device 124 or the key fob 126, the learning module 116 may be configured to confirm that the ID 128 of the mobile device 124 or key fob 126 is authorized, such as by querying the authentication data 166 based on the ID 128 responsive to wirelessly receiving the ID 128 with or before the command.

Responsive to the vehicle 102, or more particularly the learning module 116, being placed in a learning mode (“Yes” branch of block 302), in block 304, the learning module 116 may monitor for the occurrence of an object movement at the rear end 108 of the vehicle 102. In one or more embodiments, after placing the learning module 116 into a learning mode, a user may begin performing object movements at the rear end 108 of the vehicle that enable the learning module 116 to generate the classifier 164. If the learning module 116 is in the actuation learning mode, then object movements may be provided by the user that are examples of actuation gestures. If the learning module 116 is in the non-actuation learning mode, then object movements may be provided by the user that are examples of non-actuation gestures.

Exemplary actuation gestures performed by the user may include, without limitation, kicks towards and/or under the rear end 108 of the vehicle 102 that include one or more of the following characteristics: a relatively slow kick, a regular speed kick, a relatively fast kick, a kick with a bent knee, a kick from the middle of the bumper 114, a kick from the side of the bumper 114, a kick straight towards the vehicle 102, a kick angled towards the vehicle 102, a kick relatively near the vehicle 102, a kick relatively far from the vehicle 102, a high kick relatively close to the bumper 114, a low kick relatively close to the ground, a kick in fresh water (e.g., puddle, rain), and a kick in saltwater (e.g., ocean spray). Exemplary non-actuation gestures performed by the user may include, without limitation, object movements with one or more of the following characteristics: walking past or standing near the rear end 108, picking up and/or dropping off an inanimate object near the rear end 108, stomping near the rear end 108, movement of an inanimate object, such as metal cylinder, towards and then away from the rear end 108, splashing water towards the rear end 108, rain, cleaning and/or polishing the rear end 108, using a high pressure washer on the rear end 108, and taking the vehicle 102 through a car wash.

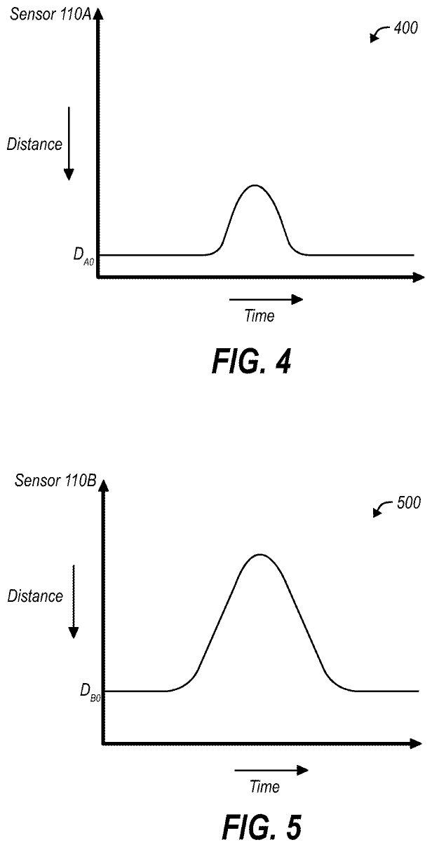

The learning module 116 may be configured to monitor for an object movement at the rear end 108 of the vehicle 102 based on proximity signals generated by the proximity sensors 110. For example, FIG. 4 illustrates a proximity signal 400 that may be generated by the proximity sensor 110A responsive to an actuation gesture being performed at the rear end 108 of the vehicle 102, and FIG. 5 illustrates a proximity signal 500 that may be generated by the proximity sensor 110B responsive to the actuation gesture. The proximity signals 400, 500 may form the proximity signal set generated by the proximity sensors 110 responsive to an object movement that is an actuation gesture.

Each of the proximity signals 400, 500 may illustrate movement of the object, in this case the leg 112, towards and then away from a different one of the proximity sensors 110 over time. Specifically, the proximity signal 400 may illustrate movement of the leg 112 towards and then away from the proximity sensor 110A over time, and the proximity signal 500 may illustrate movement of the leg 112 towards and then away from the proximity sensor 110B. In the illustrated embodiment, the vertical axis in the positive direction represents decreasing distance between the leg 112 and one of the proximity sensors 110, and the horizontal axis in the positive direction represents the passage of time.

When no moving object is within detection range of the proximity sensors 110, the proximity sensors 110 may generate a baseline value, which may be different for each of the proximity sensors 110 based on the position of the proximity sensor 110 relative to the vehicle 102, and the current environment of vehicle 102. For instance, in the illustrated embodiment, FIG. 4 illustrates that the proximity sensor 110A has a baseline value D_{A0}m, and FIG. 5 illustrates that the proximity sensor 110B has a baseline value D_{B0} that differs from the baseline value D_{A0}. When an object comes within detection range of one of the proximity sensors 110, the slope of the signal generated by the proximity sensor 110 may increase. When the slope of the signal generated by the proximity sensor 110 becomes greater than a set threshold slope for at least a set threshold time, or the level of the signal generated by the proximity sensor 110 becomes greater than the baseline value of the proximity sensor 110 by at least a set threshold value, the learning module 116 may be configured to determine that an object movement is occurring at the rear end 108 of the vehicle 102.

Responsive to identifying an object movement at the rear end 108 of the vehicle 102 (“Yes” branch of block 304), in block 306, proximity signals may be received from each of the proximity sensors 110 and stored. In one or more embodiments, responsive to a first one of the proximity sensors 110 generating a signal indicating an object movement, the learning module 116 may be configured record and store as proximity signals the signals generated by each proximity sensors 110. These proximity signals may form a proximity signal set generated responsive to an object movement.

Each proximity signal may include a same time span starting at least at the time a first one of the proximity sensors 110 indicates the start of an object movement to at least the time until a last one of the proximity sensors 110 indicates completion of the object movement. Similar to detecting the start of an object movement, the learning module 116 may be configured to identify the end of an object movement responsive to the slope of all the signals generated by the proximity sensors 110 being less than a set threshold slope for at least a set threshold time, or by each of the proximity sensors 110 returning its baseline value. By each proximity signal having a same time span, the learning module 116 is able to generate a classifier 164 that considers the distance of the object from each proximity sensor 110 during the object's movement. Each proximity signal may also include the signal generated by the pertinent proximity sensor 110 before and/or after the object movement. Referring to FIGS. 4 and 5, for example, the proximity signals 400, 500 each includes the signal generated by the proximity sensors 110A, 110B respectively before and after the respective proximity sensor 110A, 110B generated a signal indicating the object movement.

In block 308, the proximity signals of the received proximity set may be normalized. Specifically, responsive to receiving the proximity signals from the proximity sensors 110, the learning module 116 may be configured to normalize the proximity signals to a same baseline value or a substantially similar baseline value based on the baseline value of each proximity sensor 110. For example, responsive to the vehicle 102 being stopped or parked, the learning module 116 may be configured to determine the baseline level for each proximity sensor 110 by recording the level of the signal generated by the proximity sensor 110, such as immediately and/or while the signals generated by the proximity sensors 110 are not currently indicating an object movement.

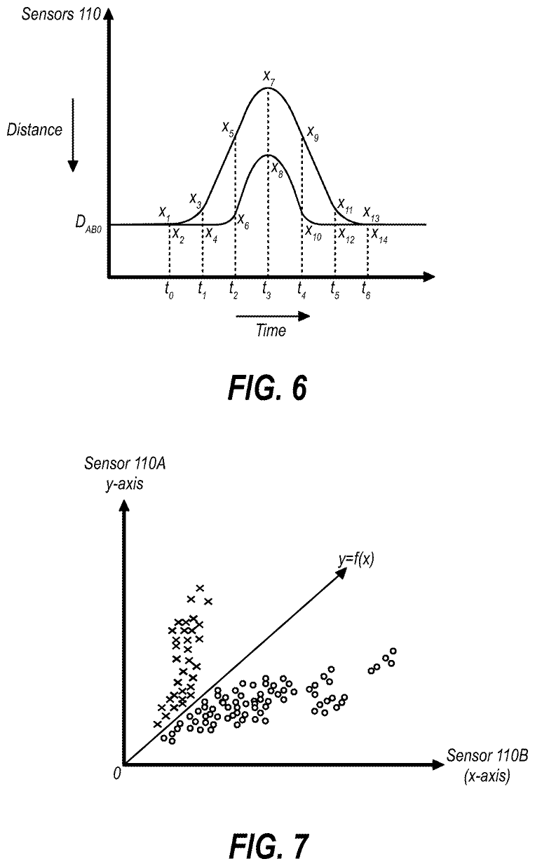

Thereafter, in block 308, the learning module 116 may be configured to add and/or subtract offsets to the proximity signals generated by the proximity sensors 110 responsive to the object movement so as to make the baseline level of each proximity signal substantially equal. The offsets may be based on the recorded baseline levels. Referring to FIGS. 4 and 5, for example, the learning module 116 may be configured to normalize the proximity signals 400, 500 by adding the difference between D_{A0} and D_{B0} to the proximity signal 400, by subtracting this difference from the proximity signal 500, or by subtracting D_{A0} and D_{B0} from the proximity signals 400, 500 respectively. The latter example may cause each proximity signal 400, 500 to have a same baseline level of zero. FIG. 6 illustrates the proximity signals of FIGS. 4 and 5 after these signals have been normalized to a same baseline level of D_{AB0}.

In block 310, new data may be generated for the training data 162 from the normalized proximity signals. The new data may indicate the proximity signals by including several training data points derived from the normalized proximity signals. Each training data point may link the proximity signals generated responsive to the detected object movement to each other. For example, each trading data point may be associated with a different time t, and may include a value sampled from each proximity signal generated responsive to the detected object movement at the time t. The learning module 116 may be configured to generate the training data points by sampling each of the generated proximity signals at regular time intervals, and grouping the samples taken at a same regular time interval in a training data point. In other words, each of the training data points may include the samples of the proximity signals taken at a same one of the regular time intervals.

Referring to FIG. 6, for example, the learning module 116 may be configured to sample the normalized proximity signals at regular time intervals, which may include to through t₆ as shown in the illustrated embodiment. Thereafter, the learning module 116 may group the values sampled from the proximity signals at a given time interval in a training data point. Thus, based on the illustrated embodiment, the learning module 116 may generate a training data point that groups the value sampled from each proximity signal at time t₀ (e.g., (x₁, x₂)), may generate another training data that that groups the value sampled from each proximity signal at time t₁ (e.g., (x₃,x₄)), may generate another training data point that groups the value sampled from each proximity signal at time t₂ (e.g., (x₅,x₆)), and so on. The learning module 116 may be configured to sample the normalized proximity signals at a preset rate such as 50 Hz or 100 Hz to generate the training data points.

In block 312, a determination may be made of whether the received proximity signals, or more particularly the training data points derived therefrom, should be associated with the actuation case or the non-actuation case. The learning module 116 may be configured to make this determination based on which learning mode the vehicle 102, or more particularly the learning module 116, was in when the detected object movement occurred. Specifically, if the learning module 116 was in the actuation learning mode, the learning module 116 may be configured to assume that the object movement was intended as an actuation gesture and to correspondingly determine that the training data points should be associated with the actuation case. Alternatively, if the learning module 116 was in the non-actuation learning mode, the learning module 116 may be configured to assume that the object movement was intended as a non-actuation gesture and to corresponding determine that the training data points should be associated with the non-actuation case.

Responsive to determining that the training data points should be associated with the actuation case (“Yes” branch of block 312), in block 314, the training data points may be associated with the actuation case within the training data 162, such as by the learning module 116. Alternatively, responsive to determining that that the training data points should be associated with the non-actuation case (“No” branch of block 312), in block 316, the training data points may be associated with the non-actuation case within the training data 162, such as by the learning module 116. The new training data 162 may thus include the training data points derived from the proximity signals generated responsive to the detected object movement, and may indicate whether the training data points are associated with the actuation case or the non-actuation case based on which learning mode the learning module 116 was in when the object movement occurred.

In addition to the new data described above, the training data 162 may also include previously generated data indicating proximity signal sets generated responsive to previous object movements performed while the learning module 116 was in one of the learning modes. Similar to the new data, the previous data may include training data points derived from the previous proximity signal sets, and may associate each of the previous proximity signal sets, or more particularly the training data points derived therefrom, with either the actuation case or the non-actuation case depending on whether the previous proximity set was generated responsive an object movement occurring while the learning module 116 was in the actuation learning mode or the non-actuation learning mode respectively.

In block 318, the learning module 116 may generate a classifier 164 based on application of the training data 162 to a machine learning algorithm. The classifier 164 may include a function that improves the ability of the access module 158 to recognize and differentiate actuation gestures and non-actuation gestures occurring at the rear end 108 of the vehicle 102 while the vehicle 102, or more particularly the learning module 116, is in the normal operating mode. The learning module 116 may be configured to generate the classifier 164 by applying to the machine learning algorithm the following data: the proximity signals generated responsive to the detected object movement, or more particularly the training data points derived from the proximity signals; the association of the proximity signals generated responsive to the detected object movement, or more particularly of the training data points derived from the proximity signals, with the actuation case or the non-actuation case; and the proximity signals, or more particularly the training data points, and the associations indicated by the previous data included in the training data 162.

FIG. 7, for example, is a graph of exemplary training data 162 and of an exemplary classifier 164 generated by application of the training data 162 to a machine learning algorithm that is a support vector machine. The training data 162 may include training data points associated with the actuation case (e.g., generated responsive to an object movement during the actuation learning mode) and training data points associated with the non-actuation case (e.g., generated responsive to an object movement during the non-actuation learning mode). Each of the training data points may include a value sampled from the proximity signal generated by the proximity sensor 110A responsive to a given object movement during one of the learning modes and a value sampled from the proximity signal generated by the proximity sensor 110B responsive to the given object movement. In the illustrated embodiment, the training data points associated with the actuation case are represented by an “x”, and the training data points associated with the non-actuation case are represented by an “o”. Each of the training data points are plotted with the x-axis being for the value of the training data point sampled from a proximity signal generated by the proximity sensor 110B and the y-axis being for the value of the training data point sampled from a proximity signal generated by the proximity sensor 110A.

The learning module 116 may generate a function f(x) for the classifier 164 by applying the training data 162 illustrated in FIG. 7 to the support vector machine. Specifically, responsive to receiving the training data 162, the support vector machine implemented by the learning module 116 may be configured to generate a hyperplane that separates the training data points associated with the actuation case and the training data points associated with the non-actuation case with a greatest margin. The function f(x) may mathematically define the hyperplane. For example, the function f(x) may be configured such that the distance between the nearest data point on each side of the function f(x) and the function f(x) is maximized. The function f(x) may be generated using, without limitation, a hard margin linear algorithm, a soft margin linear algorithm, the kernel trick, a sub-gradient descent algorithm, or a coordinate descent algorithm.

The function f(x) may separate potential data points derived from potential proximity signals generated by the proximity sensors 110 into one of two classes: an actuation class and a non-actuation class. The actuation class of potential data points may be associated with the actuation case and may thus include the training data points associated with the actuation case in the training data 162, and the non-actuation class of potential data points may be associated with the non-actuation case and may thus include the training data points associated with the non-actuation case in the training data 162. For example, as shown in the illustrated embodiment, the function f(x) may define a hyperplane serving a boundary between the classes. All the potential data points above f(x) are in the actuation class, and all the potential data points below the function f(x) are in the non-actuation class. When a proximity signal set is generated responsive to an object movement while the vehicle 102 is in the normal operating mode, the access module 158 may be configured to identify whether the proximity set represents an actuation gesture or a non-actuation gesture based on whether at least a threshold amount of the proximity set is greater than f(x), and is correspondingly included in the actuation class.

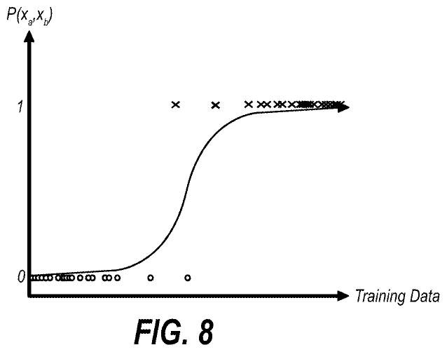

As a further example, FIG. 8 illustrates a graph of exemplary training data 162 and of an exemplary classifier 164 generated by application of the training data 162 to a machine learning algorithm that is a logistic regression machine. In the illustrated embodiment, the training data points of the training data 162 associated with the actuation case are represented by an “x”, and the training data points of the training data 162 associated with the non-actuation case are represented by an “o”.

The graph may include horizontal axes for each value of a given data point (xₐ, x_{b}), where xₐ is a value sampled at a given time interval from a proximity signal generated by the proximity sensor 110A responsive to an object movement, and x_{b} is a value of the same data point sampled at the given time interval from a proximity signal generated by the proximity sensor 110B responsive to the object movement. The vertical axis may represent a probability function P(xₐ, x_{b}) of the classifier 164. Given a data point (xₐ, x_{b}), the function P(xₐ, x_{b}) may be configured to output a probability that the proximity signal set from which the given data point was derived represents an actuation gesture. Specifically, the logistic regression machine may use the following formula for P(xₐ, x_{b}):

$$P ( {x}_{a} , {x}_{b} ) = \frac{1}{1 + {e}^{- ( {β}_{0} + {β}_{0} {x}_{a} + {β}_{2} {x}_{b} )}}$$

where β₀, β₁, and β₂ are regression coefficients of the probability model represented by the function.

The logistic regression machine implemented by the learning module 116 may be configured to determine the regression coefficients based on the training data 162. Specifically, the logistic regression machine may be configured determine values for β₀, β₁, and β₂ that minimize the errors of the probability function relative to the training data points of the training data 162 associated with the actuation case, which should ideally have a probability of one, and relative to the training data points of the training data 162 associated with the non-actuation case, which should ideally have a probability of zero. Thus, the probability output by the probability function for each training data point associated with the actuation case may be greater than the probability output by the function for each of the training data points associated with the non-actuation case. The logistic regression machine may be configured to calculate values for the regression coefficients based on the training data 162 using a maximum likelihood estimation algorithm such as, without limitation, Newton's method or iteratively reweighted least squares (IRLS).

In block 320, the generated classifier 164 may be set as active, such as by the learning module 116. Thereafter, the process 300 may return to block 302 to determine whether the vehicle 102, or more particularly the learning module 116, is still in a learning mode. If so (“Yes” branch of block 302), then the rest of the process 300 may repeat. Specifically, the learning module 116 may generate additional training data 162 from a proximity set generated by the proximity sensors 110 responsive to an object movement, associate the additional training data 162 with the actuation case or non-actuation case based on the learning mode of the learning module 116, and generate an updated classifier 164 by applying the additional and previous training data 162 to a machine learning algorithm. If the learning module 116 is no longer in a learning mode (“No” branch of block 302), then the learning module 116 may continue monitoring for activation of one of the learning modes while the vehicle 102, or more particularly the access module 158, operates to determine whether a detected object movement is an actuation gesture or a non-actuation gesture using the active classifier 164.

Specifically, responsive to receiving a proximity signal set generated by the proximity sensors 110 responsive to an object movement at the rear end 108 of the vehicle 102 during the normal vehicle operating mode, the access module 158 may be configured to sample the signals of the proximity set at regular time intervals. Thereafter, the access module 158 may generate proximity data points each being associated with a different one of the regular time intervals and including the samples of the proximity signals taken at the regular time interval associated with the proximity data point. The access module 158 may then apply the proximity data points to the active classifier 164 to determine whether the object movement was an actuation gesture or a non-actuation gesture.

Referring to FIG. 7, for example, responsive to determining that at least a set threshold number or at least a set threshold percentage of the proximity data points are in actuation class based on the function f(x) (e.g., a given proximity data point (xₐ, x_{b}) is in the actuation class if xₐ is greater than f(x_{b})), the access module 158 may be configured to determine that the object movement is an actuation gesture. If not, then the access module 158 may be configured to determine that the object movement is a non-actuation gesture. Referring to FIG. 8, for example, responsive to determining that the probability generated by the probability function P(xₐ, x_{b}) for each of at least a set threshold number or at least a set threshold percentage of the proximity data points is greater than a set threshold probability, the access module 158 may be configured to determine that the object movement is an actuation gesture. If not, then the access module 158 may be configured to determine that the object movement is a non-actuation gesture.

While the vehicle 102 and learning module 116 are in the normal operating mode, the learning module 116 may still be configured to generate additional training data 162 and update the classifier 164 based on the rules 168. Each of the rules 168 may indicate criteria for assuming that one or more object movements recently classified as non-actuation gestures by the access module 158 were indeed attempted actuation gestures. For example, one of the rules 168 may indicate that responsive to the access module 158 classifying at least a set number of proximity signal sets as being generated responsive to non-actuation gestures, followed by a manual actuation of the liftgate 104, such as by using the manual actuator 118, the mobile device 124, or key fob 126, within a set time span, the learning module 116 should assume each of the proximity signal sets were generated responsive to actuation gestures. Responsive to identifying occurrence of one of the rules 168, the learning module 116 may generate additional training data 162 from the proximity sets that implicated the rule 168, associate the additional training data 162 with the actuation case, update the classifier 164 by applying the additional training data 162 and previous training data 162 to a machine learning algorithm, and set the new classifier 164 as active as described above.

In some embodiments, the vehicle 102, or more particularly the learning module 116, may maintain different training data 162 for each user. In this way, the learning module 116 may generate classifiers 164 that are specific to different users and thereby represent the particular movement characteristics of different users. For instance, one user may on average perform an actuation gesture faster or at a different distance from the vehicle 102 than another user, which may result in the generation of different proximity sets for each user. By maintaining different training data 162 and classifiers 164 for different users rather than a compilation of training data 162 and a single classifier 164 for all users, each classifier 164 may function to better recognize actuation gestures by the user for which the classifier 164 is stored.

To this end, the controller data 160 may include training data 162 and a classifier 164 for each ID 128 authorized in the authentication data 166. Responsive to a user bringing his or her mobile device 124 or key fob 126 in communication range of the wireless transceivers 122 while the vehicle 102 is in normal operating mode, the mobile device 124 or key fob 126 may automatically transmit its ID 128 to the access module 158. The access module 158 may then be configured to retrieve the classifier 164 associated with the received ID 128. While the user's mobile device 124 or key fob 126 remains in communication range of the wireless transceivers 122, the access module 158 may utilize the retrieved classifier 164 to determine whether an object movement occurring at the rear end 108 of the vehicle 102 is an actuation gesture or a non-actuation gesture as described above. Similarly, if the learning module 116 is performing the process 300 while the user's mobile device 124 or key fob 126 is in communication range of the wireless transceivers 122, or the learning module 116 recognizes occurrence of one of the rules 168 while the user's mobile device 124 or key fob 126 is in communication range of the wireless transceivers 122, the learning module 162 may utilize training data 162 specific to the received ID 128 to generate an updated classifier 164 specific to the received ID 128.

As shown in the embodiment illustrated in FIG. 3, the learning module 116 may be configured to generate a new or updated classifier 164 each time an object movement is detected while the vehicle 102 is in a learning mode. In alternative embodiments, the learning module 116 may be configured to generate new training data 162 responsive to each object movement that occurs while the vehicle 102 is in a learning mode, but not generate a new or updated classifier 164 based on the training data 162 until instructed by the user. In this way, the user may perform several consecutive object movements, such as those described above, to form the basis of the new or updated classifier 164. For example, after the user has performed several object movements while the learning module 116 is in the actuation learning mode and has performed several object movements while the learning module 116 is in the non-actuation learning mode, the user may interact with the HMI 120, the mobile device 124, or the key fob 126 to cause the learning module 116 to exit the learning mode and activate the normal operating mode. Responsive to such an interaction, the learning module 116 may apply the training data 162 generated responsive to the several object movements performed during each learning mode to generate the new or updated classifier 164.

The embodiments described herein provide the ability of a vehicle with a gesture-controlled liftgate to recognize and distinguish between actuation gestures and non-actuation gestures. Specifically, the vehicle may include a controller configured to perform the specific and unconventional sequence of receiving proximity signal sets generated by proximity sensors of the vehicle responsive to object movements at the rear of the vehicle, sampling each of the proximity signal sets, generating training data points for each proximity set based on the samples, and associating each of the training data points with an actuation case or non-actuation case based on which learning mode the vehicle 102 was in when the object movement lending to generation of the training data point occurred. Based on the application of this training data to a machine learning algorithm, the controller may generate a classifier that generalizes the differences between actuation gestures and non-actuation gestures. The controller may then utilize the classifier 164 to improve the controller's ability to recognize and distinguish varying actuation gestures and varying non-actuation gestures, and correspondingly enhance reliability of the gesture-controlled liftgate.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence/lane diagrams, and/or block diagrams. In certain alternative embodiments, the functions, acts, and/or operations specified in the flowcharts, sequence/lane diagrams, and/or block diagrams may be re-ordered, processed serially, and/or processed concurrently consistent with embodiments of the invention. Moreover, any of the flowcharts, sequence/lane diagrams, and/or block diagrams may include more or fewer blocks than those illustrated consistent with embodiments of the invention.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

What is claimed is:

1. A vehicle including a powered liftgate, the vehicle comprising:
first and second proximity sensors positioned at a rear end of the vehicle; and
at least one controller coupled to the first and second proximity sensors and configured to
responsive to a first object movement at the rear end of the vehicle during a first vehicle mode, associate first and second proximity signals generated by the first and second proximity sensors respectively in response to the first object movement with an actuation case, the first and second proximity signals illustrating the movement of the first object towards and then away from the first and second proximity sensors respectively;
responsive to a second object movement at the rear end of the vehicle during a second vehicle mode, associate third and fourth proximity signals generated by the first and second proximity sensors respectively in response to the second object movement with a non-actuation case, the third and fourth proximity signals illustrating the movement of the second object towards and then away from the first and second proximity sensors respectively;
generate a classifier based on application of the first, second, third, and fourth proximity signals, the association of the first and second proximity signals with the actuation case, and the association of the third and fourth proximity signals with the non-actuation case to a machine learning algorithm; and
responsive to a third object movement associated with the actuation case at the rear end of the vehicle during a third vehicle mode
determine that the third object movement is associated with the actuation case based on application of fifth and sixth proximity signals generated by the first and second proximity sensors respectively in response to the third object movement to the classifier, the fifth and sixth proximity signals illustrating the movement of the third object towards and then away from the first and second proximity sensors respectively, and responsive to the determination, transmit a signal to actuate the liftgate.

2. The vehicle of claim 1, wherein the first object movement and the third object movement are each a kick under a bumper of the rear end of the vehicle, and the second object movement is the second object passing by the rear end of the vehicle.

3. The vehicle of claim 1, wherein the at least one controller is configured to:
responsive to receiving the first and second proximity signals, generate first training data points each linking the first proximity signal with the second proximity signal, wherein the at least one controller is configured to associate the first and second proximity signals with the actuation case by being configured to associate the first training data points with the actuation case; and
responsive to receiving the third and fourth proximity signals, generate second training data points each linking the third proximity signal with the fourth proximity signal, wherein the at least one controller is configured to associate the third and fourth proximity signals with the non-actuation case by being configured to associate the second training data points with the actuation case,
wherein the at least one controller is configured to generate the classifier based on application of the first, second, third, and fourth proximity signals, the association of the first and second proximity signals with the actuation case, and the association of the third and fourth proximity signals with the non-actuation case to the machine learning algorithm by being configured to generate the classifier based on application of the first training data points, the second training data points, the association of the first training data points with the actuation case, and the association of the second training data points with the non-actuation case to the machine learning algorithm.

4. The vehicle of claim 3, wherein the at least one controller is configured to:
generate the first training data points by sampling each of the first and second proximity signals at first regular time intervals, each of the first training data points including the samples of the first and second proximity signals taken at a same one of the first regular time intervals; and
generate the second training data points by sampling each of the third and fourth proximity signals at second regular time intervals, each of the second training data points including the samples of the third and fourth proximity signals taken at a same one of the second regular time intervals.

5. The vehicle of claim 3, wherein the machine learning algorithm is a support vector machine, and the classifier comprises a function that separates a first class of potential data points generated from the first and second proximity sensors responsive to an object movement and a second class of potential data points generated from the first and second proximity sensors responsive to an object movement, the first class of potential data points including the first training data points associated with the actuation case, and the second class of potential data points including the second training data points associated with the non-actuation case.

6. The vehicle of claim 3, wherein the machine learning algorithm is a logistic regression machine, and the classifier includes a function configured to generate a probability that a data point generated from the first and second proximity sensors responsive to an object movement is associated with the actuation case, the probability output by the function for each of the first training data points being greater than the probability output by the function for each of the second training data points.

7. The vehicle of claim 1, wherein the machine learning algorithm is a support vector machine, and the classifier includes a function that separates a first class of potential data points derived from proximity signals generated by the first and second proximity sensors responsive to an object movement and a second class of potential data points derived from potential proximity signals generated by the first and second proximity sensors responsive to an object movement, the first class being associated with the actuation case and the second class being associated with the non-actuation case.

8. The vehicle of claim 7, wherein the at least one controller is configured to, responsive to receiving the fifth and sixth proximity signals:
sample the fifth and sixth proximity signals at regular time intervals;
generate proximity data points each including the samples of the fifth and sixth proximity signals taken at a same one of the regular time intervals; and
responsive to determining that each of at least a set threshold number or at least a set threshold percentage of the proximity data points are in the first class of potential data points based on the function, determine that the third object movement is associated with the actuation case.

9. The vehicle of claim 1, wherein the machine learning algorithm is a logistic regression machine, and the classifier includes a function configured to output a probability that a data point derived from potential proximity signals generated by the first and second proximity sensors responsive to an object movement is associated with the actuation case.

10. The vehicle of claim 9, wherein the at least one controller is configured to, responsive to receiving the fifth and sixth proximity signals:
sample the fifth and sixth proximity signals at regular time intervals;
generate proximity data points each including the samples of the fifth and sixth proximity signals taken at a same one of the regular time intervals; and
responsive to determining that the probability generated by the function for each of at least a set threshold number or at least a set threshold percentage of the proximity data points is greater than a set threshold probability, determine that the third object movement is associated with the actuation case.

11. The vehicle of claim 1, wherein the first proximity sensor has a first baseline value, the second proximity sensor has a second baseline value that differs from the first baseline value, and the at least one controller is configured to, responsive to receiving the first and second proximity signals, prior to associating the first and second proximity signals with the actuation case and generating the classifier, normalize the first and second proximity signals to a same baseline value based on the first baseline value and the second baseline value.

12. The vehicle of claim 1, wherein the at least one controller is configured to:
responsive to a selection of a first button of a wireless key fob for the vehicle, activate the first vehicle mode; and
responsive to a selection of a second button of the wireless key fob for the vehicle, activate the second vehicle mode.

13. A system for improving operation of a powered liftgate of a first vehicle, the system comprising:
at least one processor programmed to
responsive to receiving first proximity signal sets generated by first and second proximity sensors of a second vehicle in response to a plurality of first object movements that are actuation gestures occurring at a rear end of the second vehicle, associate each of the first proximity signal sets with an actuation case, each first proximity signal set including first and second proximity signals that are generated respectively by the first and second proximity sensors and that illustrate the movement of the first object towards and then away from the first and second proximity sensors respectively;
responsive to receiving second proximity signal sets generated by the first and second proximity sensors of the second vehicle in response to a plurality of second object movements that are non-actuation gestures occurring at the rear end of the second vehicle, associate each of the second proximity signal sets with a non-actuation case, each second proximity signal set including third and fourth proximity signals that are generated respectively by the first and second proximity sensors and that illustrate the movement of the second object towards and then away from the first and second proximity sensors respectively; and
generate a classifier based on application of the first proximity signal sets, the second proximity signal sets, the association of the first proximity signal sets with the actuation case, and the association of the second proximity signal sets with the non-actuation case to a machine learning algorithm,
wherein the first vehicle, responsive to a third object movement associated with the actuation case occurring at a rear end of the first vehicle, is configured to
determine that the third object movement is associated with the actuation case based on application of a third proximity signal set generated by first and second proximity sensors of the first vehicle in response to the third object movement to the classifier, the third proximity signal set including fifth and sixth proximity signals that are generated by the first and second proximity sensors of the first vehicle respectively and that illustrate the movement of the third object towards and then away from the first and second proximity sensors of the first vehicle respectively, and
responsive to the determination, actuate the liftgate.

14. The system of claim 13, wherein the first vehicle and the second vehicle are of a same make and model.

15. The system of claim 13, wherein the at least one processor is programmed to:
responsive to receiving each first proximity signal set, generate first training data points for the first proximity signal set each linking the first proximity signal of the first proximity signal set with the second proximity signal of the first proximity signal set, wherein the at least one processor is programmed to associate the first proximity signal set with the actuation case by being programmed to associate the first training data points with the actuation case; and
responsive to receiving each second proximity signal set, generate second training data points for the second proximity signal set each linking the third proximity signal of the second proximity signal set with the fourth proximity signal of the second proximity signal set, wherein the at least one processor is programmed to associate the second proximity signal set with the non-actuation case by being programmed to associate the second training data points with the non-actuation case,
wherein the at least one processor is programmed to generate the classifier based on application of the first proximity signal sets, the second proximity signal sets, the association of the first proximity signal sets with the actuation case, and the association of the second proximity signal sets with the non-actuation case to the machine learning algorithm by being programmed to generate the classifier based on application of the first training data points generated for each first proximity signal set, the second training data points generated for each second proximity signal set, the association of the first training data points for each first proximity signal set with the actuation case, and the association of the second training data points for each second proximity signal set with the non-actuation case to the machine learning algorithm.

16. A first vehicle having a powered liftgate, the first vehicle comprising:
first and second proximity sensors positioned at a rear end of the first vehicle; and
at least one controller coupled to the first and second proximity sensors and configured to
retrieve a classifier generated by application to a machine learning algorithm of
first proximity signal sets generated by first and second proximity sensors of a second vehicle in response to a plurality of first object movements that are actuation gestures occurring at a rear end of the second vehicle and an association of each of the first proximity signal sets with an actuation case, each first proximity signal set including first and second proximity signals that are generated respectively by the first and second proximity sensors of the second vehicle and that illustrate the movement of the first object towards and then away from the first and second proximity sensors of the second vehicle respectively, and
second proximity signal sets generated by the first and second proximity sensors of the second vehicle in response to a plurality of second object movements that are non-actuation gestures occurring at the rear end of the second vehicle and an association of each of the second proximity signal sets with a non-actuation case, each second proximity signal set including third and fourth proximity signals that are generated respectively by the first and second proximity sensors of the second vehicle and that illustrate the movement of the second object towards and then away from the first and second proximity sensors of the second vehicle respectively, and
responsive to a third object movement associated with the actuation case occurring at the rear end of the first vehicle
determine that the third object movement is associated with the actuation case based on application of a third proximity signal set generated by the first and second proximity sensors of the first vehicle in response to the third object movement to the classifier, the third proximity signal set including fifth and sixth proximity signals that are generated by the first and second proximity sensors of the first vehicle respectively and that illustrate the movement of the third object towards and then away from the first and second proximity sensors of the first vehicle respectively, and
responsive to the determination, transmit a signal to actuate the liftgate.

17. The first vehicle of claim 16, wherein the machine learning algorithm is a support vector machine, and the classifier includes a function that separates a first class of potential data points derived from a proximity signal set generated by the first and second proximity sensors of the first vehicle responsive to an object movement and a second class of potential data points derived from a proximity signal set generated by the first and second proximity sensors of the first vehicle responsive to an object movement, the first class being associated with the actuation case and the second class being associated with the non-actuation case.

18. The first vehicle of claim 17, wherein the at least one controller is configured to, responsive to receiving the fifth and sixth proximity signals:
sample the fifth and sixth proximity signals at regular time intervals;
generate proximity data points each including the samples of the fifth and sixth proximity signals taken at a same one of the regular time intervals; and
responsive to determining that each of at least a set threshold number or at least a set threshold percentage of the proximity data points are in the first class of potential data points based on the function, determine that the third object movement is associated with the actuation case.

19. The first vehicle of claim 16, wherein the machine learning algorithm is a logistic regression machine, and the classifier includes a function configured to output a probability that a data point derived from a proximity signal set generated by the first and second proximity sensors of the first vehicle responsive to an object movement is associated with the actuation case.

20. The first vehicle of claim 19, wherein the at least one controller is configured to, responsive to receiving the fifth and sixth proximity signals:
sample the fifth and sixth proximity signals at regular time intervals;
generate proximity data points each including the samples of the fifth and sixth proximity signals taken at a same one of the regular time intervals; and
responsive to determining that the probability generated by the function for each of at least a set threshold number or at least a set threshold percentage of the proximity data points is greater than a set threshold probability, determine that the third object movement is associated with the actuation case.
